(19) United States
(12) Patent Application Publication
(10) Pub. No.: US 2011/0105653 A1
(43) Pub. Date: May 5, 2011

(54) Metal Complexes Used as Driers in Coatings

(76) Inventors: Ramanathan S. Lalgudi, Westerville, OH (US); Barry L. McGraw, Westerville, OH (US); Robert J. Cain, Lewis Center, OH (US)

(21) Appl. No.: 12/934,372

(22) PCT Filed: Feb. 9, 2009
(86) PCT No.: PCT/US09/33536

§ 371 Date: Jan. 19, 2011

Related U.S. Application Data
(60) Provisional application No. 61/123,568, filed on Apr. 9, 2008.

(51) Int. Cl. C08K 5/42; C09D 131/08; C08K 5/3437; C08K 5/07; C08K 5/06

(52) U.S. Cl. 524/90; 524/601; 524/357; 524/361; 524/378

(57) ABSTRACT

The present invention relates to a coating that includes a film forming binder, a solvent, and a metal complex that functions as a drier. In some preferred embodiments, the metal complex is an aluminum compound, and more particularly an aluminum compound having certain preferred structures as disclosed herein.

### CROSS-REFERENCE TO RELATED APPLICATION

This application claims the benefit of U.S. provisional application Ser. No. 61/123,568, filed Apr. 9, 2008, the disclosure of which is incorporated by reference herein.

### STATEMENT REGARDING FEDERALLY SPONSORED RESEARCH

This invention was made with Government support under NDCEE Prime Contract No. W74V8H-04-D-0005/Concurrent Technologies Corporation Task Order Number 070700209 awarded by the Deputy Assistant Secretary of the Army. The Government has certain rights in this invention.

### BACKGROUND OF THE INVENTION

This invention relates in general to coatings and in particular to driers for use in coatings.

For environmental reasons, considerable efforts have been made by the coatings industry to develop coating formulations that give off reduced levels of volatile organic compounds (VOCs). As a result, alkyd enamel coatings have been used as a replacement in many applications for lacquer coatings. The alkyd enamel coatings include alkyd resins as film forming binders. The alkyd film formed by the resins cures by oxidative crosslinking. While alkyd enamel coatings are low in VOCs, they often have a disadvantage of relatively slow “dry” and/or cure times, particularly at ambient temperatures.

Driers are materials added to alkyd coatings to speed their cure time by accelerating the oxidative crosslinking process. Commercial driers used in coatings are generally composed of various metal salts, such as carboxylic acid salts of cobalt, zirconium, calcium or manganese. Unfortunately, these driers often possess inadequate storage stability due to hydrolysis of the drier and adsorption of the drier on other components of the coating.

Therefore, it would be desirable to provide improved driers for use in coatings.

### SUMMARY OF THE INVENTION

The present invention relates to a coating that comprises a film forming binder, a solvent, and a metal complex that functions as a drier. In some preferred embodiments, the metal complex is an aluminum compound, and more particularly an aluminum compound having certain preferred structures as disclosed herein.

### DETAILED DESCRIPTION OF THE PREFERRED EMBODIMENT

The present invention relates to improved driers for use in coatings. The coating can be any general type such as paint, primer, lacquer, glaze or the like.

The driers are metal complexes, also known as coordination compounds, which include metal atoms surrounded by ligands. Any type of metal atom can be used, such as aluminum, nickel, copper, cobalt or cadmium. In a particular embodiment, the metal atom is aluminum.

The metal can be complexed with any suitable ligands which surround the metal. In some particular embodiments the ligands are organic, and more particularly they may include aromatic or aliphatic compounds. More particularly, in some embodiments the metal complexes are metal quinoxolates, metal oxadiazoles or metal triazoles. In other embodiments, the metal complexes are metal alkoxides, metal alkoxide beta-diketonates or metal beta-diketonates.

In some particular nonlimiting examples, the metal complex is an aluminum complex that includes one or more of the following chemical structures, which as shown from left to right are named tris(8-hydroxyquinoline)aluminum salt, tris(8-hydroxyquinoline-5-sulfonic acid) aluminum salt, and aluminum 2,4-pentanedionate.

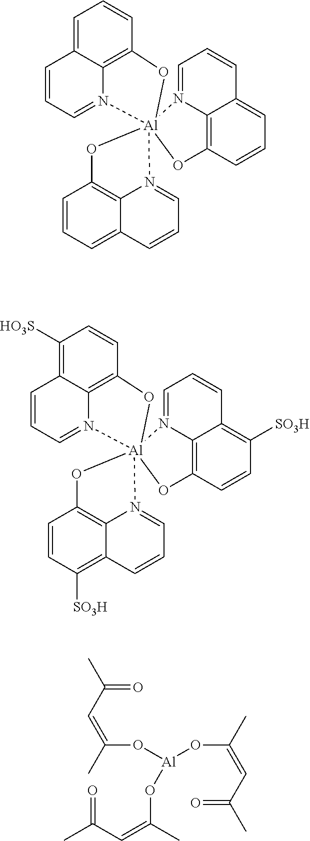

The coating also includes a film forming binder that forms a film on a surface of the coated substrate, and that usually imparts adhesion of the coating to the substrate and binds together the other coating components. Any suitable type of film forming binder or a combination of different ones can be used in the coating. Some examples are alkyd-based binders and latex-based binders which result in what are known as latex paints and alkyd paints. Some film forming materials are synthetic or natural resins. Examples of synthetic resins that may be suitable include film forming polymers such as alkyds, acrylates, urethanes, epoxies, silicones, fluorpolymers, vinyl polymers, polyesters, butadienes, styrenes, and the like.

In some embodiments the binder cures by oxidative crosslinking. For example, in some particular embodiments the binder is an alkyd resin or a modified alkyd resin. Alkyd resins are conventionally made by reaction of a dihydric or polyhydric alcohol (such as ethylene glycol or glycerol) with a polybasic acid (such as phthalic acid or phthalic anhydride), usually with a drying oil modifier. Some nonlimiting examples of modified alkyd resins include silicone-modified alkyd resins, isocyanate-modified alkyd resins (often called uralkyds), oil modified polyesters and alkyd acrylic hybrids.

In some embodiments, when the film forming binder is a resin, the Hildebrand solubility parameter of the resin is within a range of from about 15 (MPa)^{1/2} to about 25 (MPa)^{1/2}. The solubility parameter of the resin may be adjusted by combining one or more polymers to the resin, for example, to an alkyd or modified alkyd resin. Any suitable polymer(s) can be used for this purpose. Some nonlimiting examples of such polymers include coumarone-indene resin, ester gum, furfuryl alcohol resin, phenolic resin, poly(oxytane) polyurethane, and polydimethylsiloxane.

The coating also includes any type of solvent, or any combination of different solvents, suitable for use in coatings. When the coating is applied on an substrate, the solvent evaporates leaving behind the other coating components on the surface of the substrate. The solvent acts as the carrier for the other components and adjusts the viscosity of the coating. Examples of organic-based solvents include ketones such as acetone, methylethyl ketone or methylisobutyl ketone, toluene, benzene, ethyl acetate, white spirit, alkanes, cycloalkanes, other aromatic compounds, and isoparaffinic solvents. Examples of aqueous-based solvents include water, and water-based solutions such as water-alcohol mixtures and the like.

The driers can be used with either organic-based solvents or aqueous-based solvents. For example, some of the metal complexes are water soluble and would function as stable and efficient driers for water based alkyd coatings. The solubility of the drier in water could be achieved by using any suitable water soluble complexing agent, such as 8-hydroxyquinoline-5-sulfonic acid. An example of a water soluble metal complex is the above-described tris(8-hydroxyquinoline-5-sulfonic acid) aluminum salt.

In some embodiments, the solvent is a combination of at least two solvents which differ in their hydrogen bonding capacity. In general, coating solvents can be classified into three groups: 1) weakly hydrogen-bonded liquids, such as hydrocarbons, and chloro- and nitro-paraffins; 2) moderately hydrogen-bonded liquids, such as ketones, esters, ethers and ether-alcohols; and 3) strongly hydrogen-bonded liquids, such as alcohols and water. The solvents in the combination are in different groups.

Also, in some embodiments, the solvent stabilizes the metal complex used as the drier (i.e., it stabilizes the structure of the metal ion complexed with the surrounding ligands). Any suitable solvent or combination of different solvents can be used. For example, the solvent may be a diacetone alcohol and/or a methyl ether.

In addition to the above-mentioned components, the coating can optionally also include one or more other components suitable for use in coatings. For instance, such components may include anti-chalking additives, pigments, thickeners, extenders, dispersants, lubricants, wetting agents, suspension aids, thixotropic agents, water repellants, and the like.

The coating can be produced in any suitable manner, for example by combining the components in a mixer, disperser, mill or other suitable apparatus. The components can be combined in any suitable order.

The coating is applied on a substrate in any suitable marmer such as by air-spraying, brushing, rolling, or other means of applying coatings. The coating can be applied in any thickness suitable for providing corrosion detection.

The following examples are for illustrative purposes and should not be construed to limit the scope of the invention.

### EXAMPLES

### Example 1

### Synthesis of tris(8-hydroxyquinoline)aluminum Salt

In a 50 ml beaker 2.5 grams of 8-hydroxyquinoline was added to 10 grams of dimethyl acetamide (DMAC) followed by slow addition of aluminum sulfate solution (2.48 grams dissolved in 10 mL of distilled water). The precipitate was filtered and washed with acetone and dried.

### Example 2

### Alkyd Paint Containing tris(8-hydroxyquinoline)aluminum Salt

Alkyd paint (procured from Sherwin Williams type: MIL-DTL-11195G Type II Enamel, Lusterless, Fast Dry, VOC Compliant, Blue, 35109) 10 grams was weighed in a plastic jar and added 0.56 grams of tris(8-hydroxyquinoline)aluminum salt followed by 1.11 grams of acetone. The contents were mixed well in Flacktek mixture (3000 RPM for 1 min) and applied on a SS panel (2 mil wet drawdown) and the drying time with respect to coating hardness was recorded using pencil hardness test (ASTM D3363). The properties of the paint film cured at room temperature and at 80° C. are listed in Table 1 and Table 2 respectively.

### Example 3

### Alkyd Paint Containing Aluminum 2,4-pentanedionate

Alkyd paint (procured from Sherwin Williams type: MIL-DTL-11195G Type II Enamel, Lusterless, Fast Dry, VOC Compliant, Blue, 35109) 10 gram was weighed in a plastic jar and added aluminum 2,4-pentanedionate followed by 1.11 grams of acetone. The contents were mixed well in Flacktek mixture (3000 RPM for 1 min) and applied on a SS panel (2 mil wet drawdown) and the drying time with respect to coating hardness was recorded using pencil hardness test (ASTM D3363). The properties of the paint film cured at room temperature and at 80° C. are listed in Table 1 and Table 2 respectively.

TABLE 1
Pencil hardness of room temperature cured coatings

| | Time | | | | | |
|---|---|---|---|---|---|---|
| | | | 45 | 60 | 75 | 1440 min |
| | 15 min | 30 min | min | min | min | cure |
| Sample Description | cure | cure | cure | cure | cure | (24 hours) |
| Al-8HQ complex in | <5B | <5B | <5B | <5B | <5B | <5B |
| paint | | | | | | |
| Al-ACAC complex | <5B | <5B | <5B | <5B | <5B | <5B |
| in paint | | | | | | |
| AOC1020X drier in | <5B | <5B | <5B | <5B | 5B | 3B |
| paint | | | | | | |

TABLE 2
Pencil hardness of 80° C. cured coatings

| | Time | | | | | |
|---|---|---|---|---|---|---|
| | | | 45 | 60 | 75 | 1440 min |
| | 15 min | 30 min | min | min | min | cure |
| Sample description | cure | cure | cure | cure | cure | (24 hours) |
| Al-8HQ complex in | <5B | <5B | <5B | <5B | <5B | B |
| paint | | | | | | |
| Al-ACAC complex | <5B | <5B | <5B | <5B | <5B | F |
| in paint | | | | | | |
| AOC1020X drier in | <5B | <5B | 4B | 3B | 3B | HB |
| paint | | | | | | |

### Control Example 1

### Alkyd Paint Containing Commercial Aluminum Drier (Aluminum Carboxylate)

Alkyd paint (procured from Sherwin Williams type: MIL-DTL-11195G Type II Enamel, Lusterless, Fast Dry, VOC Compliant, Blue, 35109) 10 grams were weighed in a plastic jar and added AOC 1020X followed by 1.11 grams of acetone. The contents were mixed well in Flacktek mixture (3000 RPM for 1 min) and applied on a SS panel (2 mil wet drawdown) and the drying time was recorded. The properties of the paint film cured at room temperature and at 80° C. are listed in Table 1 and Table 2 respectively.

The properties of paint film obtained using the driers indicate that aluminum complexed with functional groups other than carboxylic acid are not detrimental for oxidative crosslinking reactions. Also, the driers are not susceptible to hydrolysis and therefore provide storage stability to solvent based as well as water based alkyd paints. Unlike commercial driers, the driers did not get adsorbed into the pigments of the paint. Furthermore, the metal complexes could inhibit corrosion.

### Example 4

### (Run 1 to Run 4): Coating Formulations with Combination of Metal Drier and Different Co-Solvents

TABLE 3

| | | Run #2 | Run #2 | | |
|---|---|---|---|---|---|
| Material | Run #1 | a&b | c&d | Run #3 | Run #4 |
| F93LC350 | Material from | 2546.8 | 2546.8 | 2557.2 | 2176.9 |
| Acetone | big tank | 785.0 | 819.4 | 594.0 | 724.0 |
| Oxsol 100 | F93LC350 | 0.0 | 0.0 | 313.8 | 0.0 |
| AOC 1020X | reduced with | 84.6 | 173.9 | 84.9 | 76.1 |
| Beckosol | acetone and | 0.0 | 0.0 | 0.0 | 114.6 |
| | t-butyl acetate | | | | |

Using the coating formulations shown in Table 3, fifty projectiles were coated and dried at ambient temperature and as well as approximately 140° F. Prior to coating on the projectiles, the viscosities of the formulations were checked and adjusted down to about 20-22 seconds Zahn #2. This was done to control coating appearance. Table 4 below shows the run order, cure conditions and general observations of the trial. The total cure/dry time for each of the projectiles was approximately 20 minutes prior to being picked up and packed by the automated coating system.

TABLE 4

| | | | Application Viscosity | Final Film | |
|---|---|---|---|---|---|
| Run | Type | Temp. | (Zahn #2 seconds) | Build (mils) | Observations |
| 1A | Control from big | 76-78° F. | 25 | 1.0-1.3 | Line down, parts packed |
| | tank (acetone/ | | | | after about 1 hour - run |
| | TBAC reduction) | | | | repeated as 4A |
| 2A | 0.5% aluminum | 76-78° F. | 19.5 | 0.8-1.2 | Some marks on box, |
| | | | | | slight print left |
| 2C | 1% aluminum | 76-78° F. | 20.5 | 1.4-1.6 | Few marks on box, no |
| | | | | | print, much less mar |
| | | | | | marks compared to 1A |
| | | | | | control |
| 3A | 0.5% aluminum | 76-78° F. | 20.5 | 1.4-1.6 | No tacky feel, no odor, |
| | (acetone/Oxsol | | | | no marks on box, no |
| | reduction) | | | | print |
| 4A | Repeat of 1A with | 76-78° F. | 25 | 1.2-1.4 | Few marks on box, mar |
| | standard line time | | | | marks on part, residual |
| | | | | | odor |
| 1B | Control from big | About | 25 | N/A | Significant marks on |
| | tank | 140° F. | | | box, tacky, prints left |
| | | | | | in film |
| 3B | 0.5% aluminum | About | 20.5 | 1.0-1.5 | Few marks on box, |
| | (acetone/Oxsol | 140° F. | | | slight tack, slight |
| | reduction) | | | | odor - not as good as 3A |
| 4B | 0.5% aluminum | About | 22 | 1.5-1.6 | Significant orange peel |
| | 5% Beckosol | 140° F. | | | appearance, tacky few |
| | acetone reduction | | | | marks on box |
| 2D | 1% aluminum | About | 20.5 | 1.7-1.8 | Test box was previously |
| | | 140° F. | | | used with marks already |
| | | | | | on cardboard - could |
| | | | | | not tell which marks |
| | | | | | were new. Parts takes |
| | | | | | a print, ambient cure |
| | | | | | was much better |
| 2B | 0.5% aluminum | About | 19.5 | 1.7-1.8 | Some mar marks, takes |
| | | 140° F. | | | a print, sheen |
| | | | | | appearance - ambient |
| | | | | | was much better |

The addition of either 0.5% or 1% aluminum in combination with Oxsol and acetone reduction improved the abrasion resistance and appearance of mar marks. The best performance was observed at ambient curing temperatures.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A coating comprising:
a film forming binder;
a solvent; and
a metal complex that functions as a drier.

2. The coating of claim 1 wherein the metal complex is an aluminum complex.

3. The coating of claim 2 wherein the aluminum complex includes one or more of the following chemical structures:

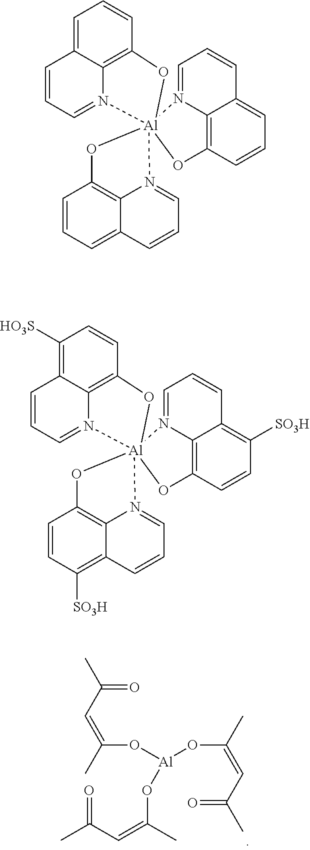

4. The coating of claim 1 wherein the binder cures by oxidative crosslinking.

5. The coating of claim 4 wherein the binder is an alkyd resin or a modified alkyd resin.

6. The coating of claim 3 wherein the drier is water dispersible.

7. The coating of claim 3 wherein the drier is stable in water based alkyds.

8. The coating of claim 3 wherein the drier catalyzes oxidative polymerization of water based alkyds.

9. The coating of claim 3 wherein the drier catalyzes oxidative polymerization of water based alkyd modified polyesters, polyurethanes, epoxies, silicone and polymers containing alkene functional groups.

10. The coating of claim 1 wherein the film forming binder is a resin having a Hildebrand solubility parameter within a range of from about 15 (MPa)^{1/2} to about 25 (MPa)^{1/2}.

11. The coating of claim 10 wherein the solubility parameter of the resin is adjusted by combining one or more polymers to the resin.

12. The coating of claim 11 wherein the polymers are selected from coumarone-indene resin, ester gum, furfuryl alcohol resin, phenolic resin, poly(oxytane) polyurethane, polydimethylsiloxane, and mixtures thereof.

13. The coating of claim 1 wherein the solvent is a combination of at least two solvents which differ in their hydrogen bonding capacity.

14. The coating of claim of 1 wherein the solvent stabilizes the metal complex.

15. The coating of claim 14 wherein the solvent is selected from diacetone alcohol and methyl ether.
